(19) United States
(12) Patent Application Publication
(10) Pub. No.: US 2025/0036113 A1
(43) Pub. Date: Jan. 30, 2025

(54) LOG FILE AGGREGATOR AND DATA VISUALIZATION FOR SEMICONDUCTOR CONTROL SYSTEMS

(71) Applicant: Onto Innovation Inc., Wilmington, MA (US)

(72) Inventors: Christopher Reed Smith, Bloomington, MN (US); Sonia Carol Chase, Plano, TX (US)

(21) Appl. No.: 18/358,495

(22) Filed: Jul. 25, 2023

(51) Int. Cl. G05B 23/02

(52) U.S. Cl. CPC G05B 23/0221; G05B 23/0272

(57) ABSTRACT

The present disclosure presents technology designed to streamline the analysis of log data in semiconductor fabrication environments. Semiconductor fabrication environments are often characterized by large amounts of diverse log data generated across various subsystems, with each subsystem producing its unique log data format due to different hardware and software components. The present technology addresses this by converting the multitude of raw log data formats into a single, timestamp sorted data table, which eases the task of log analysis, facilitating the extraction of key events and the reconstruction of the processing sequence. Following the conversion, the technology can sift through the data for predefined patterns and significant events, generating a dictionary of critical data over time. Visualization of this data enables tracking of the fabrication process or display of process steps via a graphical user interface, thus boosting problem detection and resolution.

### TECHNICAL FIELD

The present disclosure relates generally to semiconductor fabrication, and more particularly to log file aggregators and techniques for data visualization for semiconductor manufacturing control systems.

### BACKGROUND

Semiconductor device fabrication is a process in the production of integrated circuit (IC) chips such as computer processors, microcontrollers, and memory chips found in everyday electronics. The fabrication involves a series of photolithographic and chemical processing steps, including thermal oxidation, thin-film deposition, and etching, to create electronic circuits on a wafer or other substrate. During fabrication, the specific techniques and their order may be repeated multiple times and can vary depending on the manufacturer and the type of device being made. The end result of this process is a highly complex and precise electronic device that is essential for modern technology and communication.

Device yield, also known as die yield, refers to the percentage of functioning chips or dies on a wafer, as number of chips produced on a wafer can be affected by the size of the chips and the diameter of the wafer. In the past, yield degradation was a commonly caused by dust particles. However, with the advancement of technology, modern semiconductor fabrication facilities are equipped with automated systems and operate in a nitrogen-rich, hermetically sealed “clean room” environment. This helps to improve yield by reducing contamination and ensuring a higher percentage of functioning microchips in a wafer. Within the cleanrooms, automated material handling systems further enhance yield by transporting wafers from machine to machine with greater efficiency.

With the reduction in dust particle contaminants, the next biggest contributors to yield degradation are process variation, the issues with the process itself and problems or setting associated with the tools used in semiconductor device fabrication.

### SUMMARY

Some aspects of the disclosure are directed to technology to convert raw log data files into a single data table sorted by a converted timestamp. After aggregating the data, key events can be extracted to make the log analysis easier and to recreate the processing sequence in the system.

In accordance with certain aspects of the disclosure, multiple formats of data logs, such as CSV (comma separated values), JSON (JavaScript Object Notation), or MOSS (Smalltalk data format) can be converted. The conversion can be specified by an input specification, which has details about where the files are located, how to convert timestamp data, and what data to include in the output.

In certain implementations, after the data is converted by the software, a data table is output with all of the log data sorted by a converted timestamp. After log aggregation, the software analyzes the data by searching for predefined patterns and important events are flagged. When an important event is found (e.g., an alarm, a job start, a robot movement), the software creates a dictionary containing all of the important data for that moment in time. For example, the dictionary could contain all active alarms and locations of all material within the system. These events can then be used to “playback” and create a visualization of the system over time. For example, the movement of a wafer through the fabrication process from a robot to a process module can be tracked and displayed on a GUI. In another example, the process steps of a lithography process or deposition process can be tracked and displayed on a GUI.

Aspects of the present disclosure relate to a method for monitoring events in a manufacturing process performed by a manufacturing system, including the steps of: receiving first log entries from a first subsystem of the manufacturing system, the first log entries having a first data format and first timestamps, and being associated with first events of the first subsystem: receiving second log entries from a second subsystem of the manufacturing system, the second subsystem being different from the first subsystem, the second log entries having a second data format and second timestamps, the second log entries being associated with second events of the second subsystem, the second data format being different from the first data format; and merging the first log entries and the second log entries to generate a merged log of merged log entries, including entries corresponding to the first log entries and entries corresponding to the second log entries, the merged log entries including merged log timestamps corresponding to the first timestamps and the second timestamps, respectively, the merged log entries being associated with merged log events corresponding to the first events and the second events, respectively, the merging including: converting both the first data format and the second data format into a merged log data format of the merged log entries, the merged log data format being different from the first data format and the second format; and sorting the merged log entries into chronological order based on the merged log timestamps.

In certain implementations, the method further includes a step of generating a data table of the merged log entries. In certain implementations, the method further includes a step of comparing the merged log entries to predefined data patterns to determine that at least two of the merged log entries correspond to merged log events having predefined event types. In certain implementations, the method further includes a step of generating a visualization, at a graphical user interface, of the manufacturing system over time, including visual representations of the merged log events corresponding to the at least two of the merged log entries, the visual representations being generated in chronological order based on the merged log timestamps of the at least two of the merged log entries.

In certain implementations, the method further includes a step of generating a dictionary of events of the manufacturing system having the corresponding timestamp for each of the at least two of the merged log entries. In certain implementations, the method further includes a step of generating a visualization, at a graphical user interface, of the manufacturing system over time based on the dictionaries of events.

In certain implementations, the method further includes a step of populating at least one of the first timestamps or the second timestamps with an approximate time stamp. In certain implementations, the method further includes a step of converting the first timestamps and the second timestamps into merged log timestamps, wherein the conversion involves supplementing the information contained in at least one of the first time stamps or second timestamps with data representing a prescribed order of the first events and the second events, to enable the merged log events to be chronologically ordered where at least one of the first timestamps or the second timestamps alone lack the detail necessary to enable chronological ordering.

Another aspect of the present disclosure relates to a computer system for file aggregation, including one or more processors, and non-transitory computer readable storage media encoding instructions which, when executed by the one or more processors, causes the computer system to create: a query engine configured to receive first log entries from a first subsystem of the manufacturing system, the first log entries having a first data format and first timestamps, and being associated with first events of the first subsystem, and receive second log entries from a second subsystem of the manufacturing system, the second subsystem being different from the first subsystem, the second log entries having a second data format and second timestamps, the second log entries being associated with second events of the second subsystem, the second data format being different from the first data format: a converter engine configured to convert both the first data format and the second data format into a merged log data format of the merged log entries, the merged log data format being different from the first data format and the second data format; and an aggregator engine configured to merge the first log entries and the second log entries to generate a merged log of merged log entries, including entries corresponding to the first log entries and entries corresponding to the second log entries, the merged log entries including merged log timestamps corresponding to the first timestamps and the second timestamps, respectively, the merged log entries being associated with merged log events corresponding to the first events and the second events, respectively; and to sort the merged log entries into chronological order based on the merged log timestamps.

In certain implementations, the aggregator engine is configured to generate a data table of the merged log entries. In certain implementations, the system further includes an event tagging engine configured to compare the merged log entries to predefined data patterns to determine that at least two of the merged log entries correspond to merged log events having predefined event types. In certain implementations, the system further includes a visualization engine configured to generate a visualization, at a graphical user interface, of the manufacturing system over time, including visual representations of the merged log events corresponding to the at least two of the merged log entries, the visual representations being generated in chronological order based on the merged log timestamps of the at least two of the merged log entries. In certain implementations, the system further includes an event dictionary engine configured to generate a dictionary of events of the manufacturing system having a corresponding timestamp. In certain implementations, the visualization engine generates the visualization, at a graphical user interface, of the manufacturing system over time based on the dictionary of events.

Yet another aspect of the present disclosure relates to a computer program product residing on a non-transitory computer readable storage medium having a plurality of instructions stored thereon, which when executed by a processor, cause the processor to perform operations for file aggregation including: receiving first log entries from a first subsystem of the manufacturing system, the first log entries having a first data format and first timestamps, and being associated with first events of the first subsystem: receiving second log entries from a second subsystem of the manufacturing system, the second subsystem being different from the first subsystem, the second log entries having a second data format and second timestamps, the second log entries being associated with second events of the second subsystem, the second data format being different from the first data format: merging the first log entries and the second log entries to generate a merged log of merged log entries, including entries corresponding to the first log entries and entries corresponding to the second log entries; and generating a visualization, at a graphical user interface, of the manufacturing system over time, including visual representations of the merged log events corresponding to the at least two of the merged log entries, the visual representations being generated in chronological order based on the merged log timestamps of the at least two of the merged log entries.

In certain implementations, the manufacturing system is a semiconductor substrate manufacturing system. In certain implementations, the first subsystem is a subsystem of a first semiconductor substrate manufacturing tool. In certain implementations, the second subsystem is a subsystem of a second semiconductor substrate manufacturing tool that is different from the first semiconductor substrate manufacturing tool.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic view of a manufacturing system, in accordance with an embodiment of the disclosure.

FIG. 2 is a schematic view depicting an algorithm architecture, in accordance with an embodiment of the disclosure.

FIG. 3 is a schematic view depicting a conversion and merger of multiple noncompatible data arrays into a single, merged data array, in accordance with an embodiment of the disclosure.

FIG. 4 is a schematic view depicting an assignment of one or more tags to a row of information contained in a data array, in accordance with an embodiment of the disclosure.

FIG. 5 is a schematic view depicting a generation of a dictionary of events, which is used to drive a visualization of a manufacturing system, in accordance with an embodiment of the disclosure.

FIG. 6 is a flowchart depicting a computer implemented method for monitoring events in the manufacturing process performed by a manufacturing system, in accordance with an embodiment of the disclosure.

FIG. 7 depicts example physical components of a computer subsystem of the manufacturing system of FIG. 1.

### DETAILED DESCRIPTION

In typical semiconductor fabrication environments, control software is heavily involved in the automated material handling systems and the various deposition and lithography chambers. The various subsystems and tools of such an environment typically generate many large amounts of runtime logging data distributed across multiple computers, operating in real time. Since the overall system includes different hardware and software components from multiple sources, log data typically has different formatting for each subsystem. For example, a first subsystem (e.g., a lithography tool, etc.) can maintain log data in a first format (e.g., comma separated values, etc.), while a second subsystem (e.g., a metrology tool, etc.) can maintain log data in a second format (e.g., JavaScript Object Notation, etc.). Thus, when an issue affecting product yield occurs during processing, it can be difficult to analyze all of the log data and recreate what happened on all of the subsystems to get a view of the entire system and determine what went wrong and when, and how the error may be corrected.

The present disclosure describes technology configured to convert various formats of raw log data files into a single, sorted data table using a converted timestamp or merged log timestamp. Embodiments of the present disclosure simplify log analysis and help recreate the processing sequence in the manufacturing system by extracting key events. The conversion process can be defined by an input specification, which specifies the file location, timestamp conversion, and output data. After conversion, the software can output a data table containing all log data sorted by the converted timestamp. The technology can then analyze the data for predefined patterns and important events, which can be flagged and used to create a dictionary containing critical data over a period of time. In an embodiment, a representation of the manufacturing system can be visualized and played back over time, such as tracking the movement of a wafer through the fabrication process or displaying the process steps of a lithography or deposition process on a graphical user interface.

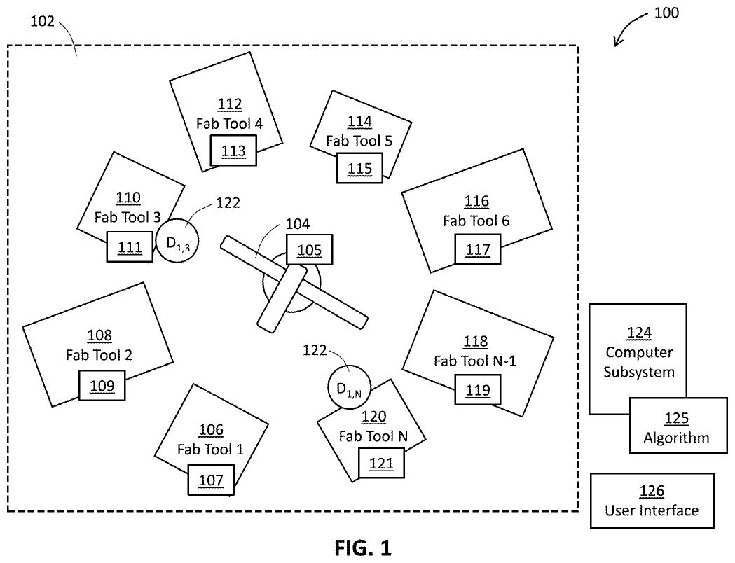

Referring to FIG. 1, a manufacturing system 100 is depicted in accordance with an embodiment of the disclosure. As previously discussed, the fabrication of a semiconductor device typically involves several processes carried out by various fabrication subsystems 104, 106, 108, 110, 112, 114, 116, 118, and 120. Each fabrication subsystem can be a tool that carries out a process step, such as a robotic arm, a deposition tool, edging tool, ion implementation tool, metrology tool, chemical mechanical polishing tool, thermal processing tool, lithography tool, inspection tool, etc. At times, faults or errors in the control or instructions provided to the subsystems can occur during a particular step or while transferring between subsystems within the manufacturing system 100, resulting in temporary interruptions to production. Additionally, issues or events within a subsystem 104, 106, 108, 110, 112, 114, 116, 118, and 120 can lead to fabrication defects, reducing yield. By understanding the connections in the data collected by the subsystems 104, 106, 108, 110, 112, 114, 116, 118, and 120, manufacturers can minimize downtime and enhance yield rates.

In embodiments, the manufacturing system 100 can include multiple fabrication lines 102 for fabricating semiconductor devices. Each of the fabrication lines 102 can include a plurality of fabrication subsystems 104, 106, 108, 110, 112, 114, 116, 118, and 120. For example, the fabrication line 102 can include N fabrication subsystems, such as a first fabrication subsystem 104, a second fabrication subsystem 106, a third fabrication subsystem 108, a fourth fabrication subsystem 110, a fifth fabrication subsystem 112, a sixth fabrication subsystem 114, a seventh fabrication subsystem 116, an N−1 fabrication subsystem 118, and an Nth fabrication subsystem 120, where N is an integer greater than 1. The fabrication tools can include robotic material handling subsystems, and various chambers and tools used in the wafer fabrication process, such as oxidation systems, epitaxial reactors, diffusion systems, ion implantation equipment, physical vapor deposition systems, chemical vapor deposition systems, photolithography equipment, and etching equipment, among other types of tools. While only nine fabrication tools are depicted in the fabrication line 102, fewer or more fabrication tools can be utilized. Fewer or more fabrication steps can also be performed, including hundreds of fabrication or processing steps in some examples.

A semiconductor device 122 can be fabricated by proceeding through the fabrication line 102. Each of the fabrication subsystems 104, 106, 108, 110, 112, 114, 116, 118, and 120 can transport or perform a process step on a semiconductor device 122 (e.g., a wafer or a substrate of a wafer or a panel). In some examples, the semiconductor device 122 can be processed by the same fabrication subsystem more than once. For instance, multiple deposition, lithography, and/or etching steps can be performed on the semiconductor device 122. The semiconductor device 122 and its respective step can be represented with the following nomenclature: D_{A,B}, where A represents the wafer number and B represents the processing stage of the device. In the example depicted, the semiconductor device 122 is represented by D_{1,3} after processing by fabrication subsystem 110. After the Nth processing step, the first semiconductor device 122 is represented by D_{1,N}.

During the fabrication process, control software controls the physical actions performed by each of the fabrication subsystems 104, 106,108, 110, 112, 114, 116, 118, and 120, including automated material handling and precise control of the semiconductor device 122 by the automated material handling subsystem 104 within and between the fabrication subsystems 106, 108, 110, 112, 114, 116, 118, and 120. In one nonlimiting example, the fabrication line 102 can include an edge chamber 106, a deposition chamber 108, an annealing chamber 110, an ion implementation chamber 112, a rapid thermal processing chamber 114, a photolithography chamber 118, and a cleaning chamber 120, although other types of fabrication subsystems and order of the fabrication subsystems is also contemplated.

Frequently, each of the fabrication subsystems 104, 106, 108, 110, 112, 114, 116, 118, and 120 involves its own, distinct control subsystem 105, 107, 109, 111, 113, 115, 117, 119, and 121, respectively. For example, each control subsystem 105, 107, 109, 111, 113, 115, 117, 119, and 121 can be represented as different source process controls distributed across multiple computers operating in real time, with each control subsystem 105, 107, 109, 111, 113, 115, 117, 119, and 121 designed to control certain aspects of a particular fabrication subsystem or process within the overall fabrication process. In many cases, each of the several distinct control subsystems 105, 107, 109, 111, 113, 115, 117, 119, and 121 maintains a runtime data log (e.g., including log entries or log data) of the various steps, settings and procedures processed by the corresponding, respective, subsystem 104, 106, 108, 110, 112, 114, 116, 118, and 120.

The log data may include information describing any action performed by the subsystem or a failure that occurred within the subsystem. For example, the data log may store information describing an event that occurs in its respective subsystem, for example, a message received by the subsystem, an error occurring during operation of the subsystem, or any other action or operation performed by the subsystem or interaction between subsystems. In some embodiments, the log data may store warning information indicating a state of the system that needs attention, for example, if a subsystem load or setting exceeds a threshold value. One example type of information stored in the data logs can include error information describing system failures or other types of errors encountered during execution of processes and applications. An error may occur if a process or an application encounters an unexpected situation or if there is an equipment malfunction.

In some embodiments, the log data can be stored in a database array (or table). An array is a data structure that is organized in a grid like manner, consisting of rows, columns, and cells. Rows are the horizontal lines in the array, and columns are the vertical lines. The intersection of a row and column form a cell, which is a single unit of data. The cells in an array can contain a variety of data types, including numbers, text, and formulas. The size of the array is determined by the number of rows and columns, and the location of a specific piece of data within the array as specified by its row and column coordinates. Alternatively, the logs may be stored as a flat file, for example, as text messages with separators between logs.

Complex manufacturing systems 100 typically have multiple control subsystems 105, 107, 109, 111, 113, 115, 117, 119, and 121, with each control subsystem generating a data log and storing different types of information. The control subsystems are not typically configured to communicate with one another. Accordingly, the log entries kept by the control subsystems 105, 107, 109, 111, 113, 115, 117, 119, and 121 can be stored in noncompatible formats, including CSV (comma separated values), JSON (JavaScript Object Notation), MOSS (Smalltalk data format), and the like. When an issue occurs during processing, it can be difficult to analyze all of the log data and recreate an occurrence of the events at the manufacturing system 100 level.

To address this problem, in embodiments, log data from each of the subsystems can be communicated to a computer subsystem 124 loaded with a file aggregator algorithm 125 configured to receive log data from the various control subsystems 105, 107, 109, 111, 113, 115, 117, 119, and 121, and reformat and combine the log data into a single data table sorted by a converted timestamp, thereby enabling specific events or windows of time to be graphically displayed on a user interface 126. Accordingly, embodiments of the present disclosure enable users to retrace a series of events to identify the source of an error, or to generally visualize the flow of materials through the manufacturing system 100. In some embodiments, the log data can be used to infer or predict the yield of semiconductor devices 122 produced by the manufacturing system 100.

In embodiments, the computer subsystem 124 can be a mobile computer, desktop computer, server computer, or other computing devices such as a server farm or cloud system configured to facilitate the communication between different fabrication subsystems 104, 106, 108, 110, 112, 114, 116, 118, and 120. The computer subsystem 124 comprises a file aggregator algorithm 125 which receives the log data generated by each control subsystem of the fabrication units representing the various steps, settings, procedures, and potential errors in diverse formats like CSV, JSON, or MOSS. The file aggregator algorithm 125 reformats and consolidates these multiple log data into a single data table based on timestamps, which can be graphically displayed on a user interface 126.

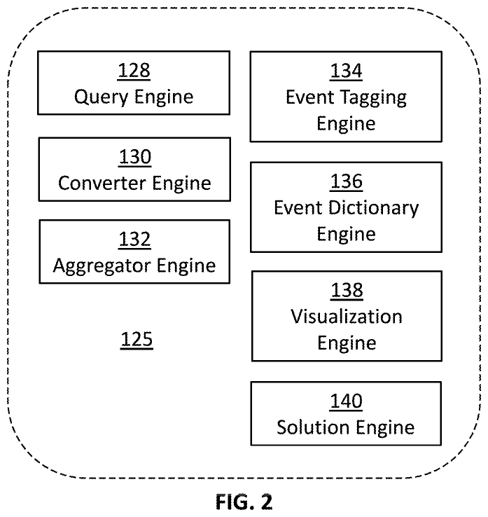

With additional reference to FIG. 2, a schematic view of the file aggregator algorithm 125 is depicted in accordance with an embodiment of the disclosure. In embodiments, the file aggregator algorithm 125 can include various modules or engines, each of which is constructed, programmed, configured, or otherwise adapted to autonomously carry out a function or set of functions. The term “engine” as used herein is defined as a real-world device, component, or arrangement of components implemented using hardware or as a combination of hardware and software, such as by a microprocessor system and a set of program instructions stored on non-transitory computer-readable storage that adapt the engine to implement a particular functionality, which (while being executed) transform the microprocessor system into a special-purpose device.

An engine can also be implemented as a combination of hardware and software, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, non-transitory data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques.

The term “engine” in this context refers to a system or subsystem, typically composed of a combination of hardware and software, that carries out a specific set of functions. An engine can be seen as a modular unit within a larger system, and these engines can be composed of sub-engines themselves. Nonlimiting examples of “engines” include: (i) a graphical processing unit (GPU) or other specialized electronic circuit designed to rapidly manipulate and alter memory to accelerate the creation of images in a frame buffer intended for output to a display device: (ii) a database management system responsible for data storage, manipulation, and retrieval, involving software for processing database queries and transactions, managing database tables and indices, and ensuring data integrity and security, as well as the underlying hardware used for data storage: or (iii) a rendering engine configured to convert HTML, CSS, JavaScript, images, and other resources for processing into a visual representation viewable by a user. In embodiments, the engines are not limited to specific hardware or software implementation and can be realized in various configurations. Additionally, the engines may operate across distributed systems, including clusters, peer to peer networks, or cloud systems.

Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality: however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

In one embodiment, the algorithm 125 can include a query engine 128 configured to communicate with each of the control subsystems 105, 107, 109, 111, 113, 115, 117, 119, and 121 to receive log data. For example, in some embodiments, the query engine 128 can send a request for each of the control subsystems 105, 107, 109, 111, 113, 115, 117, 119, and 121 to send portions of its data log to the computer subsystem 124 for further processing and storage. In other embodiments, the query engine 128 can access portions of the control subsystems 105, 107, 109, 111, 113, 115, 117, 119, and 121 to retrieve the log data.

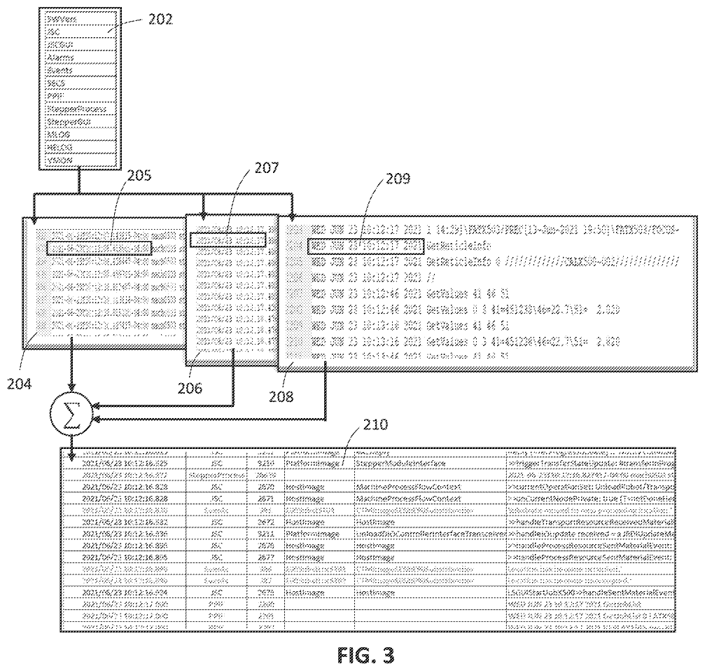

With additional reference to FIG. 3, an input specification 202 can be provided to the query engine 128 to identify a location of the relevant data sources (e.g., which control subsystems 105, 107, 109, 111, 113, 115, 117, 119, and 121 are to be queried for relevant log data). In some embodiments, the entire contents of the log data can be transferred to the computer subsystem 124. In other embodiments, only a portion of the log data from the specific queried control subsystems (e.g., log data occurring after a particular time) is communicated to the computer subsystem 124 for improved processing speeds.

In many cases, the raw log data from the various control subsystems 105, 107, 109, 111, 113, 115, 117, 119, and 121 is received in noncompatible formats. For example, as depicted in FIG. 3, first log entries 204 from the first subsystem 104, second log entries 206 from the second subsystem 106, and third log entries 208 from the third subsystem 108 are received by the computer subsystem 124 upon a query by the query engine 128. As depicted, each of the first, second, and third log entries 204, 206, 208 can include respective first timestamps 205, second timestamps 207, and third timestamps 209, in addition to other information contained within the respective data arrays. As further depicted, each of the first, second and third log entries 204, 206, 208 can be different from one another, thereby inhibiting their combination without further conversion or processing.

In embodiments, the algorithm 125 can include a converter engine 130 configured to convert or merge multiple formats of raw data into a common integratable (or merged) format. In embodiments, the input specification 202 can include instructions of how to convert the data log, including specific information about how to convert the timestamp data, and what information to include in particular rows and columns of the resulting data array.

For example, in some embodiments, conversion of the timestamp data 205, 207, 209 may require reformatting raw data into a number, which can represent the year, month, day, and time of day including hours minutes and seconds, as well as potentially other information including time zone and other calendar events. Conversion of the various columns of timestamp data 205, 207, 209 may require several steps, including removal of nonrelevant characters, lookup and replacement of textual terms (e.g., months, days of the week, etc.), and various mathematical formulas to convert the raw timestamp data into a readily combinable, compatible format.

In some cases, the timestamp data 205, 207, and 209 generated by different control subsystems may be in noncompatible formats or formats that are meaningful only within the context of the specific control subsystem to which the timestamp applies. While these formats are suitable for individual control subsystems, they often lack the necessary level of detail to definitively order the log entries associated with events across multiple control subsystems. For example, within the semiconductor wafer production process involving lithography, each control subsystems 105, 107, 109, 111, 113, 115, 117, 119, and 121 may have its own way of representing timestamps. That is, a lithography subsystem may use timestamps that provide relevant information for its specific operations but do not inherently enable the precise ordering of events across all control subsystems involved in the overall production workflow. To overcome this challenge, the received timestamp data 205, 207, and 209 is converted into a common format, enabling the various log entries to be organized chronologically.

In some embodiments, the converter engine 130 standardizes the format of the received timestamp data 205, 207, and 209 to ensure consistency across all entries into a universally accepted representation, such as “YYYY-MM-DD HH:MM:SS.” where each component (year, month, day, hours, minutes, seconds) is explicitly defined. In some embodiments, this may involve parsing the existing format into different components, such as year, month, day, and time, into separate variables or fields, while removing non-relevant characters, such as punctuation marks or textual terms. If the original timestamp data uses textual terms (e.g., month names, day of the week), the converter engine 130 may employ lookup tables or replacement rules to convert them into numerical equivalents. In some embodiments, the original timestamp data 205, 207, and 209 might lack specific details required for accurate chronological organization.

In some embodiments, the converter engine 130 can add supplementary information or perform calculations to enhance the converted timestamp data to ensure that once merged, a chronological organization of the merged data according to the converted timestamp accurately represents the actual order of events or the prescribed recipe for events. For example, the conversion can involve supplementing the information contained in the original timestamp data 205, 207, and 209 with data representing a prescribed order of the events, to enable the merged log events to be chronologically ordered where the original timestamp data 205, 207, and 209 alone lacks the detail necessary to enable chronological ordering. Where the log entries 204, 206, 208 fails to include time stamp data for each row of information, the converter engine 130 can populate the timestamp data with an approximate time stamp, which can be derived from timestamp data included in other rows within a given log entry, or timestamp data derived from other log entries.

Similarly, the converter engine 130 can perform similar processes on other information stored in the various rows, columns and cells of the data arrays representing the various log entries 204, 206, 208, including removal of nonrelevant information, reordering and adding columns, and reformatting of the information stored in each of the cells. In short, the converter engine 130 converts the log data arrays into a unified and consistent format, thereby enabling the various log entries 204, 206, 208 to be merged.

In embodiments, the algorithm 125 can include an aggregator engine 132 configured to blend, aggregate, or combine the data converted by the converter engine 130 into a single data table 210. Specifically, the aggregator engine 132 can be configured to merge the first log entry 204, second log entry 206, third log entry 208, etc. into a merged log of merged log entries. The merged log of merged log entries can be used to generate the data table 210. Further, the aggregator engine 132 can be configured to sort the data within the data table 210 by converted timestamp data, such that the log data is organized chronologically.

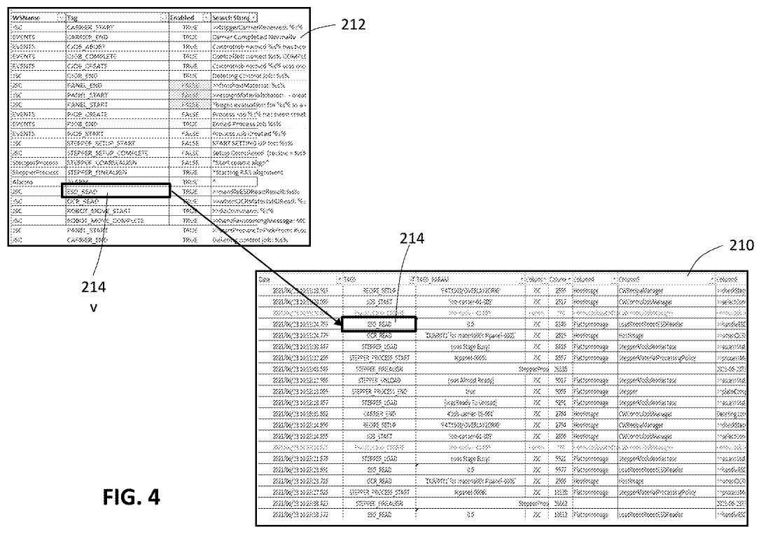

With additional reference to FIG. 4, the aggregator engine 132 can sort the data within the table 210 by the converted timestamp data, or other type of data structure used to ensure that multiple threads can access and modify a shared integer value in a safe and controlled manner, particularly where the algorithm includes multiple threads running in parallel, which can lead to race conditions and other synchronization issues. In some embodiments, the converted timestamp then can be implemented using atomic operations or clocks, and can provide a way to update the integer in a way that ensures that only one thread can access and modify the value at any given time.

For improved indexing, in some embodiments, the algorithm 125 can include an event tagging engine 134 configured to classify data included in the table 210 within one or more groups. For example, in some embodiments, the event tagging engine 134 can search text included within particular rows, columns or cells of the table 210 for particular keywords or phrases. A lookup table 212 can be accessed, to assign one or more tags 214 to a particular row or column of information, thereby having the effect of grouping the information in the row or column into a particular category.

In some embodiments, the event tagging engine 134 uses a machine learning based model trained to classify error logs. The machine learning based model receives the data table 210 as input (e.g., in the form of a vector representation), and predicts one or more tags 214 which can be assigned to a particular row or column of information to classify the information in the row or column or link the information in those cells to a particular type of error or process step associated with fabrication.

In some embodiments, the tags can be representative of events or portions of the fabrication process, (e.g., alarms, job start, robotic movements, etc.). Thereafter, data within the table 210 can be sorted or filtered according to the one or more tags 214, thereby enabling further analysis by the algorithm 125 to focus on the particular event or events represented by the one or more tags 214.

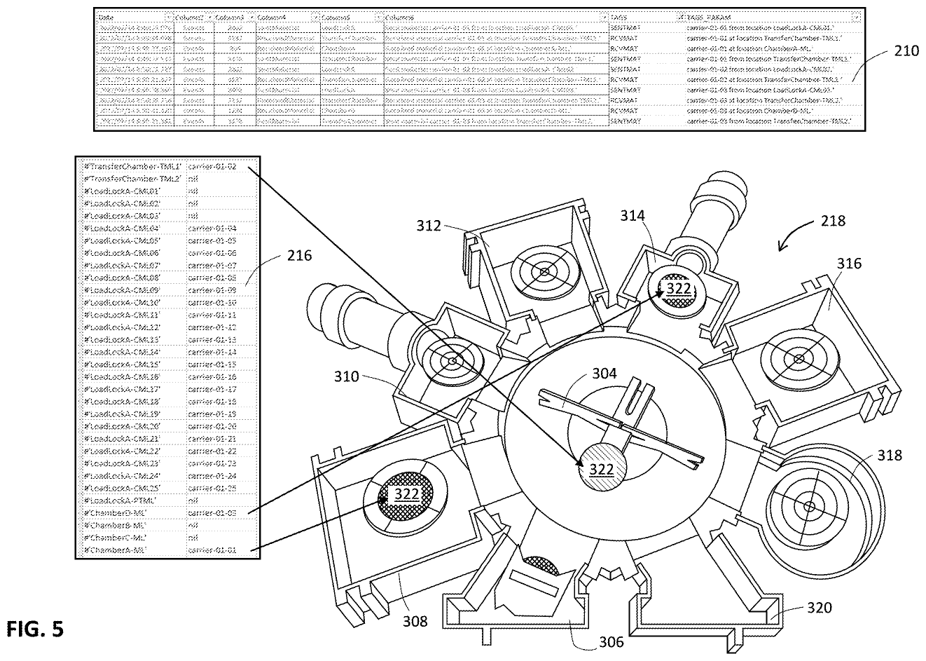

With additional reference to FIG. 5, the algorithm 125 can include an event dictionary engine 136 and visualization engine 138 configured to extract data from the table 210 and create a graphical depiction of the events or series of events taking place in the manufacturing system 100. For example, in some embodiments, data within the table 210 identified as pertaining to a key event can be extracted from the table 210 and manipulated into a series of actionable step instructions, all in a single, common data format, represented as a dictionary 216. Thereafter, the dictionary 216 can be input into visualization engine 138, for example, to create an animated visualization 218 of the manufacturing system 100, which can be displayed on the user interface 126.

For example, when an important event is flagged (e.g., an alarm, etc.), the algorithm 125 can search the data for predefined patterns or tagged events. In some embodiments, data within a timestamp window can be extracted and formatted into the dictionary 216, which contains information regarding recorded physical actions that took place in the manufacturing system 100 in the form of a series of step instructions. Thereafter, the step instructions defined by the dictionary 216 can be used to play back and create a chronologically accurate visualization 218, which can include representations of each of the fabrication subsystems 304, 306, 308, 310, 312, 314, 316, 318, and 320, as well as time-dependent positions of one or more semiconductor devices 322 during the fabrication process.

In some embodiments of the present disclosure, completion of steps within a process chamber or movement of a semiconductor device 322 throughout the fabrication process (e.g., from a robot to a process module, etc.) can be tracked and displayed on the graphical user interface 126, which can significantly reduce the time to debug and analyze log data following an error. Accordingly, embodiments of the present disclosure can result in quicker times to fix issues arising during semiconductor fabrication, which can serve to reduce downtime in manufacturing. In some embodiments, the present disclosure can be used to identify and modify events which may be contributing to a reduction in yield.

In some embodiments, the algorithm 125 can include a solution engine 140, which can be configured to analyze results presented by the event dictionary engine 136 and propose one or more solutions to address the current environment or error. For example, in some embodiments, the solution engine 140 can be pre-populated with instructions for corrective actions to be taken by a user. In other embodiments, the solution engine 140 can automatically implement one or more solutions to address an error. For example, if it is determined that a runtime error occurred in any one of the subsystems, the solution engine 140 can perform a reset on the associated control subsystem, then resume fabrication. As other examples of corrective action that can be automatically alerted and/or implemented by the solution engine 140, a subsystem can be recalibrated, repaired, or replaced.

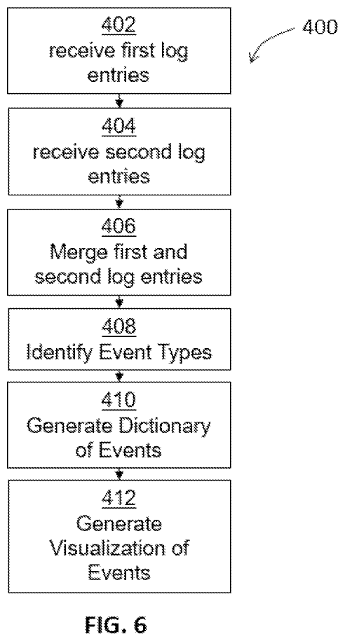

Referring to FIG. 6, a computer implemented method 400 for monitoring events in the manufacturing process performed by a manufacturing system, is depicted in accordance with an embodiment of the disclosure. The steps of the method can be performed using the computer subsystem 124 (FIG. 1).

At step 402 of the method 400, first log entries are received from the first subsystem 104 of the manufacturing system 100. The first log entries are associated with events that occur in the first subsystem 104, which can be useful in monitoring events in the manufacturing process. In embodiments, the first log entries are generated by the first subsystem 104 are in a first data format and include first timestamps.

At step 404 of the method 400, second log entries are received from the second subsystem 106 of the manufacturing system 100. The second log entries are associated with events that occurred in the second subsystem 106, which can be useful in monitoring events in the manufacturing process. In embodiments, the second log entries are generated by the second subsystem 106 and are in a second data format and include second timestamps. In embodiments, the second data format is different from the first data format, such that the first log entries are not combinable with the second log entries.

At step 406 of the method 400, the first log entries and the second log entries can be merged to generate a merged log of merged log entries, which can include entries corresponding to the first and second log entries. In embodiments, the merged log entries can include merged log timestamps corresponding to the first timestamps and the second timestamps. In some embodiments, the merging of the first log entries with the second log entries can involve converting both the first data format and the second data format into a merged log data format of the merged log entries. In embodiments, the merged log data format can be different from the first data format and the second format. Thereafter, the merged log entries can be sorted into a chronological order based on the merged log timestamps. For example, in some embodiments, the merged log entries can be presented in the form of a data table including at least one row; column and cell.

At step 408 of the method 400, the merged log entries can be compared to predefined data patterns to determine that at least two of the merged log entries correspond to merged log events having one or more predefined event types. For example, the merged log entries can be analyzed to determine if information contained in the log entries can be associated with a particular event type (e.g., alarms, job start, robotic movements, etc.). Thereafter, one or more tags 214 or other classification based notation can be added to the merged log entries.

At step 410 of the method 400, according to some embodiments, a dictionary of events within the merged log entries and associated with one or more tags 214 can be generated. In embodiments, the dictionary of events can contain information regarding recorded physical actions or steps taking place during fabrication. In embodiments, the dictionary of events can be formulated as a series of input step instructions for use by a visualization engine 138.

At step 412 of the method 400, according to some embodiments, a visualization of a series of events taking place in a manufacturing system can be produced on a graphical user interface, which can include representations of each of the fabrication subsystems 304, 306, 308, 310, 312, 314, 316, 318, and 320, as well as time-dependent positions of one or more semiconductor devices 322 during the fabrication process.

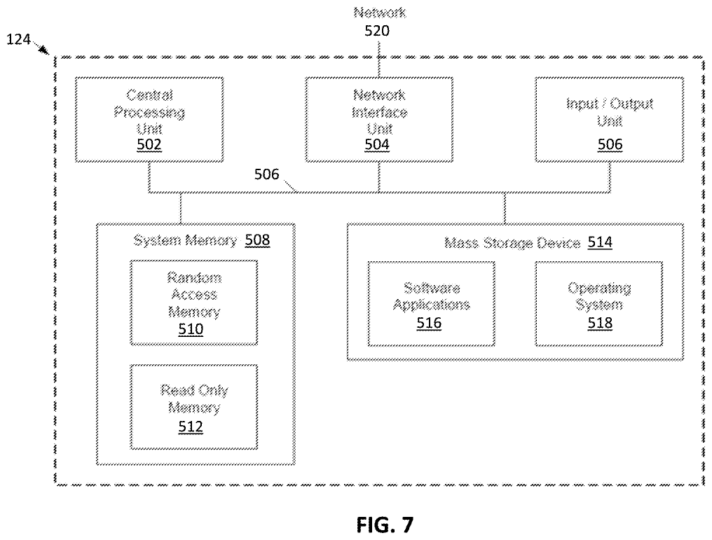

As illustrated in the embodiment of FIG. 7, the example computer subsystem 124 loaded with a file aggregator algorithm 125, which provides the functionality described herein, can include at least one central processing unit (“CPU”) 502, a system memory 508, and a system bus 506 that couples the system memory 508 to the CPU 502. The system memory 508 includes a random access memory (“RAM”) 510 and a read-only memory (“ROM”) 512. A basic input/output system containing the basic routines that help transfer information between elements within the manufacturing system 100, such as during startup, is stored in the ROM 512. The computer subsystem 124 further includes a mass storage device 514. The mass storage device 514 can store software instructions and data. A central processing unit, system memory, and mass storage device similar to that shown can also be included in the control subsystems 105, 107, 109, 111, 113, 115, 117, 119, and 121 and other computing devices disclosed herein.

The mass storage device 514 is connected to the CPU 502 through a mass storage controller (not shown) connected to the system bus 506. The mass storage device 514 and its associated computer-readable data storage media provide non-volatile, non-transitory storage for the manufacturing system 100. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the manufacturing system 100.

According to various embodiments of the invention, the computer subsystem 124 may operate in a networked environment using logical connections to remote network devices through network 520, such as a wireless network, the Internet, or another type of network. The network 520 provides a wired and/or wireless connection. In some examples, the network 520 can be a local area network, a wide area network, the Internet, or a mixture thereof. Many different communication protocols can be used.

The computer subsystem 124 may connect to network 520 through a network interface unit 504 connected to the system bus 506. It should be appreciated that the network interface unit 504 may also be utilized to connect to other types of networks and remote computing systems. The computer subsystem 124 also includes an input/output controller 506 for receiving and processing input from a number of other devices, including a touch user interface display screen or another type of input device. Similarly, the input/output controller 506 may provide output to a touch user interface display screen or other output devices.

As mentioned briefly above, the mass storage device 514 and the RAM 510 of the computer subsystem 124 can store software instructions and data. The software instructions include an operating system 518 suitable for controlling the operation of the manufacturing system 100. The mass storage device 514 and/or the RAM 510 also store software instructions and applications 516, that when executed by the CPU 502, cause the computer subsystem 124 to provide the functionality of the computer subsystem 124 discussed in this document.

Reference was made in detail to exemplary aspects of the present disclosure illustrated in the accompanying drawings. Wherever possible, the same reference numbers were used throughout the drawings to refer to the same or like parts.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A method for monitoring events in a manufacturing process performed by a manufacturing system, comprising:
receiving first log entries from a first subsystem of the manufacturing system, the first log entries having a first data format and first timestamps, and being associated with first events of the first subsystem;
receiving second log entries from a second subsystem of the manufacturing system, the second subsystem being different from the first subsystem, the second log entries having a second data format and second timestamps, the second log entries being associated with second events of the second subsystem, the second data format being different from the first data format; and
merging the first log entries and the second log entries to generate a merged log of merged log entries, including entries corresponding to the first log entries and entries corresponding to the second log entries, the merged log entries including merged log timestamps corresponding to the first timestamps and the second timestamps, respectively, the merged log entries being associated with merged log events corresponding to the first events and the second events, respectively, the merging including:
converting both the first data format and the second data format into a merged log data format of the merged log entries, the merged log data format being different from the first data format and the second data format; and
sorting the merged log entries into chronological order based on the merged log timestamps.

2. The method of claim 1, further comprising:
generating a data table of the merged log entries.

3. The method of claim 1, further comprising:
comparing the merged log entries to predefined data patterns to determine that at least two of the merged log entries correspond to merged log events having predefined event types.

4. The method of claim 3, further comprising:
generating a visualization, at a graphical user interface, of the manufacturing system over time, including visual representations of the merged log events corresponding to the at least two of the merged log entries, the visual representations being generated in chronological order based on the merged log timestamps of the at least two of the merged log entries.

5. The method of claim 3, further comprising:
for each of the at least two of the merged log entries, generating a dictionary of events of the manufacturing system having a corresponding timestamp.

6. The method of claim 5, further comprising:
generating a visualization, at a graphical user interface, of the manufacturing system over time based on the dictionary of events.

7. The method of claim 1,
wherein the manufacturing system is a semiconductor substrate manufacturing system;
wherein the first subsystem is a subsystem of a first semiconductor substrate manufacturing tool; and
wherein the second subsystem is a subsystem of a second semiconductor substrate manufacturing tool that is different from the first semiconductor substrate manufacturing tool.

8. The method of claim 1, further comprising:
populating at least one of the first timestamps or the second timestamps with an approximate time stamp.

9. The method of claim 1, further comprising:
converting the first timestamps and the second timestamps into merged log timestamps, wherein the conversion involves supplementing data contained in at least one of the first time stamps or second timestamps with supplemental data representing a prescribed order of the first events and the second events, to enable the merged log events to be chronologically ordered where at least one of the first timestamps or the second timestamps alone lack the detail necessary to enable chronological ordering.

10. A computer system for file aggregation, comprising:
one or more processors; and
non-transitory computer readable storage media encoding instructions which, when executed by the one or more processors, causes the computer system to:
receive first log entries from a first subsystem of the manufacturing system, the first log entries having a first data format and first timestamps, and being associated with first events of the first subsystem, and receive second log entries from a second subsystem of the manufacturing system, the second subsystem being different from the first subsystem, the second log entries having a second data format and second timestamps, the second log entries being associated with second events of the second subsystem, the second data format being different from the first data format;
convert both the first data format and the second data format into a merged log data format of the merged log entries, the merged log data format being different from the first data format and the second data format; and
merge the first log entries and the second log entries to generate a merged log of merged log entries, including entries corresponding to the first log entries and entries corresponding to the second log entries, the merged log entries including merged log timestamps corresponding to the first timestamps and the second timestamps, respectively, the merged log entries being associated with merged log events corresponding to the first events and the second events, respectively; and to sort the merged log entries into chronological order based on the merged log timestamps.

11. The computer system of claim 10, wherein the instructions which, when executed by the one or more processors, further causes the computer system to generate a data table of the merged log entries.

12. The computer system of claim 10, wherein the instructions which, when executed by the one or more processors, further causes the computer system to compare the merged log entries to predefined data patterns to determine that at least two of the merged log entries correspond to merged log events having predefined event types.

13. The computer system of claim 12, wherein the instructions which, when executed by the one or more processors, further causes the computer system to generate a visualization, at a graphical user interface, of the manufacturing system over time, including visual representations of the merged log events corresponding to the at least two of the merged log entries, the visual representations being generated in chronological order based on the merged log timestamps of the at least two of the merged log entries.

14. The computer system of claim 12, wherein the instructions which, when executed by the one or more processors, further causes the computer system to generate a dictionary of events of the manufacturing system having a corresponding timestamp.

15. The computer system of claim 14, wherein the instructions which, when executed by the one or more processors, further causes the computer system to generate a visualization of the manufacturing system over time based on the dictionary of events.

16. The computer system of claim 10,
wherein the first subsystem is a subsystem of a first semiconductor substrate manufacturing tool; and
wherein the second subsystem is a subsystem of a second semiconductor substrate manufacturing tool that is different from the first semiconductor substrate manufacturing tool.

17. The computer system of claim 10, wherein the instructions which, when executed by the one or more processors, further causes the computer system to populate at least one of the first timestamps or the second timestamps with an approximate time stamp.

18. The computer system of claim 10, wherein the instructions which, when executed by the one or more processors, further causes the computer system to convert the first timestamps and the second timestamps into merged log timestamps, wherein the conversion involves supplementing data contained in at least one of the first time stamps or second timestamps with supplemental data representing a prescribed order of the first events and the second events, to enable the merged log events to be chronologically ordered where at least one of the first timestamps or the second timestamps alone lack the detail necessary to enable chronological ordering.

19. A computer program product residing on a non-transitory computer readable storage medium having a plurality of instructions stored thereon, which when executed by a processor, cause the processor to perform operations for file aggregation comprising:
receiving first log entries from a first subsystem of the manufacturing system, the first log entries having a first data format and first timestamps, and being associated with first events of the first subsystem;
receiving second log entries from a second subsystem of the manufacturing system, the second subsystem being different from the first subsystem, the second log entries having a second data format and second timestamps, the second log entries being associated with second events of the second subsystem, the second data format being different from the first data format;
merging the first log entries and the second log entries to generate a merged log of merged log entries, including entries corresponding to the first log entries and entries corresponding to the second log entries; and
generating a visualization, at a graphical user interface, of the manufacturing system over time, including visual representations of the merged log events corresponding to the at least two of the merged log entries, the visual representations being generated in chronological order based on the merged log timestamps of the at least two of the merged log entries.

20. The computer program product of claim 19, the operations further comprising:
generating a dictionary of events of the manufacturing system having a corresponding timestamp for each of the at least two of the merged log entries.
